(19) United States
(12) Patent Application Publication
(10) Pub. No.: US 2006/0169732 A1
(43) Pub. Date: Aug. 3, 2006

(54) Device for dispensing two-sided adhesive pieces of an adhesive

(76) Inventor: Frits Ludvigsen, Tommerup (DK)

Correspondence Address: SUGHRUE MION, PLLC, 2100 PENNSYLVANIA AVENUE, N.W., SUITE 800, WASHINGTON, DC, 20037, US

(21) Appl. No.: 10/542,106

(22) PCT Filed: Jan. 23, 2003
(86) PCT No.: PCT/DK03/00040

§ 371 Date: Mar. 21, 2006

(51) Int. Cl. B65H 35/07; B26F 3/02

(52) U.S. Cl. 225/46; 225/56

(57) ABSTRACT

A device for dispensing two-sided adhesive pieces of an adhesive (3), comprising a support (7) for a roll (1) of a carrier strip (2) carrying a strip or pieces (3) of a two-sided adhesive. The roll (1) can rotate in a support (7) at the dispensing of carrier strip (2) and adhesive (3), a free end of the carrier strip being pulled out of the support (7) along a wall portion thereof. The wall portion is at a downstream end, relative to the movement of the carrier strip during dispensing, provided with a tear-off edge (22a) for tearing off the carrier strip (2). The tear-off edge (22a) has a V-shape, which is concave relative to the wall portion.

The present invention relates to a device for dispensing two-sided adhesive pieces of an adhesive, comprising a support for a roll of a carrier strip carrying a strip or pieces of a two-sided adhesive, in which support the roll can rotate when dispensing carrier strip and adhesive, a free end of the carrier strip being pulled out of the support along a wall portion thereof, said wall portion being, at a down-stream end relative to the movement of the carrier strip during dispensing, provided with a tear-off edge for tearing off the carrier strip.

Many devices of this kind are known, which are all provided with a rectilinear tear-off edge extending perpendicularly to the moving direction of the carrier strip during dispensing, inter alia U.S. Pat. No. 4,704,185, U.S. Pat. No. 3,274,038, U.S. Pat. No. 4,220,495, U.S. Pat. No. 4,396,455, U.S. Pat. No. 4,851,074, GB-B-1 330 120 and JP-A-2000302316 (Patent Abstracts of Japan).

A drawback to these rectilinear tear-off edges is that the tearing off takes place by pulling the free end of the carrier strip laterally, which results in a skew load on the tear-off edge and the carrier strip.

U.S. Pat. No. 4,336,097 discloses a device for dispensing an adhesive strip rolled up on a carrier strip, the carrier strip being after dispensing of the adhesive strip rolled up in a compartment in the device. A slightly curved, concave tear-off edge is provided for the adhesive strip, the adhesive strip being at the tearing off cut from the sides towards the middle of the strip. The tear-off edge consists of a blade mounted in the device. A tear-off edge with such a design puts comparatively great demands on the quality of the material providing the tear-off edge and its sharpness.

The object of the present invention is to provide a device of the kind mentioned by way of introduction, said device not suffering from the above-mentioned drawbacks.

This is obtained by a device, which is characterized in that the tear-off edge has a V-shape, which is concave relative to the wall portion.

The V-shape is preferably symmetrical relative to the free end of the carrier strip in the support during its dispensing from the support.

The V has preferably an apex angle of 40-140°, and more preferred of 60-120°.

The sides of the V are preferably substantially rectilinear.

By designing the tear-off edge as a V, a homogenous, symmetrical load on the tear-off edge is obtained at the tearing off, the load being biggest initially during tearing off at the ends of the tear-off edge close to a bigger material concentration in the support, such that the stress concentration in the support material is minimised, which makes it possible to use comparatively thin material or a weak material.

Thus an embodiment has been made possible by means of the invention, in which embodiment the wall portion with the tearing edge is made from cardboard.

In another embodiment the wall portion with the tearing edge is made from plastics.

The support is preferably provided with a roll of a carrier strip carrying a strip or pieces of a two-sided adhesive, said carrier strip being made from paper.

The adhesive is in an embodiment made from a two-sided adhesive film.

The adhesive is in another embodiment a tape coated with an adhesive on both sides.

The invention will now be explained in detail in the following by means of an example of an embodiment with reference to the drawings, in which

FIG. 1 is an elevation of a device, in which the invention can be used,

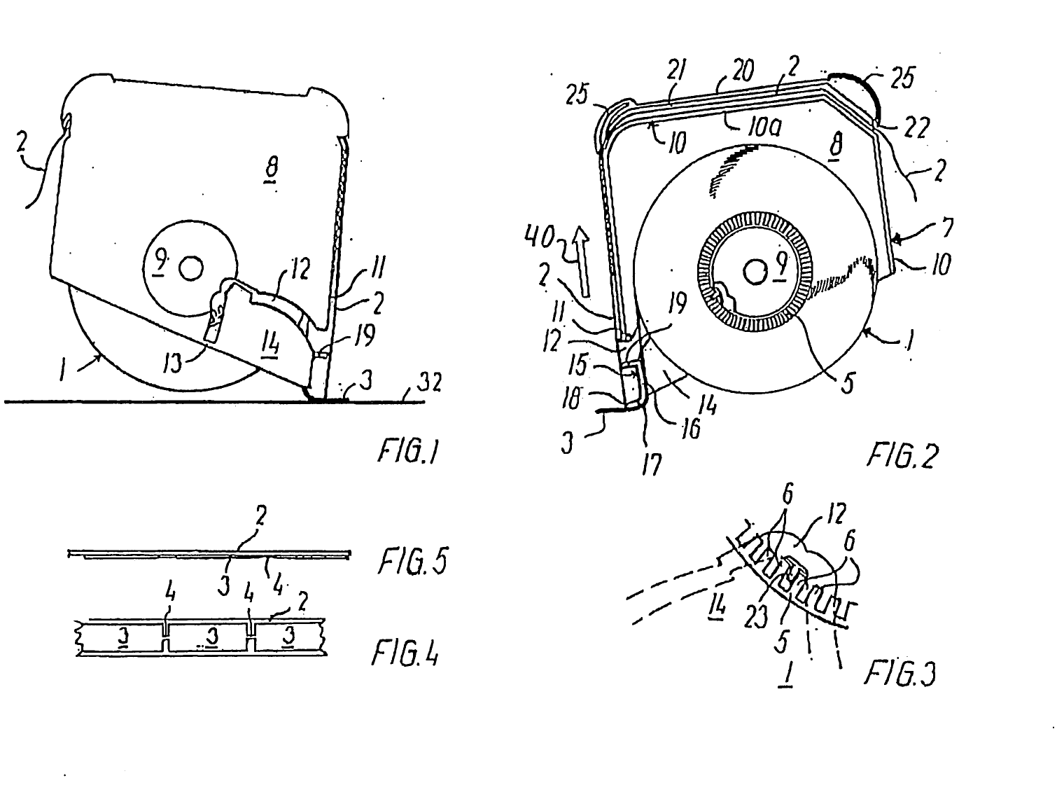

FIG. 2 shows the device in FIG. 1, seen from the opposite side,

FIG. 3 is an enlarged section of FIG. 2,

FIG. 4 shows a piece of carrier strip with pieces of tape,

FIG. 5 shows the carrier strip of FIG. 4, seen from the side,

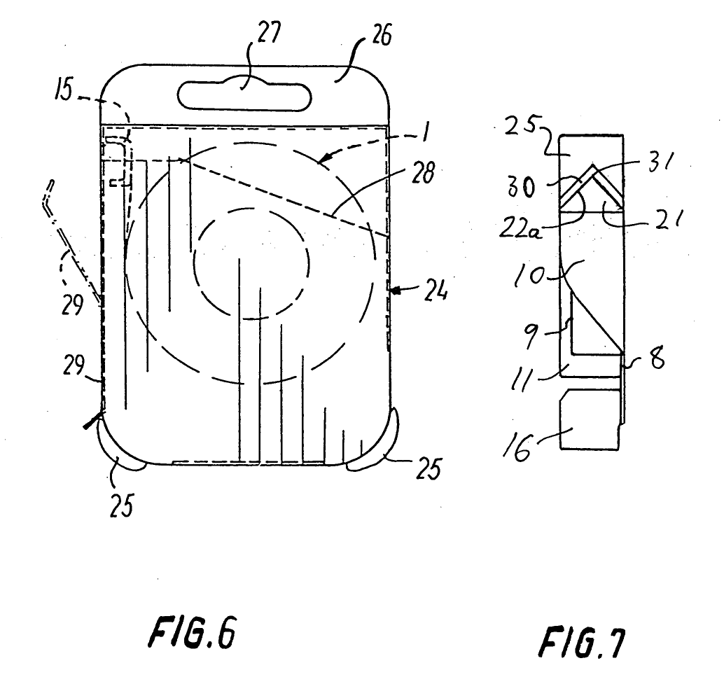

FIG. 6 shows the device in a box, and

FIG. 7 is a view seen in the direction of the arrow VII in FIG. 1, but showing the device with a tear-off edge according to the present invention.

The invention will be explained in connection with a device, which has been described in Applicant's own, not yet published European patent application no. 02388006.5.

The device for dispensing two sided adhesive tape pieces comprises a roll 1 of a carrier strip 2 holding two sided adhesive tape pieces 3. The tape pieces 3 may be of a conventional tape with a core of paper or plastic coated with an adhesive on both sides. The carrier strip 2 is likewise of a conventional type and releases easily the tape pieces 3. The carrier strip is preferably made from paper, in particular paper treated with silicone or paper treated in another way, so that it can release easily the adhesive of the tape pieces.

Adjacent tape pieces 3 are preferably mutually connected by means of a narrow material strip 4, a so-called ‘louse’.

The roll 1 is wound on a hub 5 with an internal, circular cogging with teeth 6.

The roll 1 is embedded in a support 7 in the form of a moulded plastic item having an overall wall thickness of a few millimetres or less. The support 7 comprises a side wall 8 with an essentially quadrangular contour. From the side wall 8, a hollow stub shaft 9 rises in the form of an essentially cylindrical projection extending up through the hub 5 in order to support the roll 1 in a rotational manner.

Along three of the peripheral sides of the side wall 8, a peripheral wall 10 extends. At the fourth peripheral side, the support 7 is open to permit the roll 1 protrude from the support 7.

From one end of a first portion 11 of the peripheral wall 10, a recess 12 extends into the side wall 8, into the stub shaft 9 and down to the fourth peripheral side, a narrow material strip or a hinged portion 13 being left acting as a resilient hinge to be described further below.

The recess 12 defines a resilient movable pressure base portion 14, the rest position of which is shown in FIGS. 1 and 2. The pressure base portion 14 carries a pressure base element 15 essentially in the form of a J. A vertical part 16 of the pressure base element, as seen in FIG. 2, constitutes a part of a slide for the carrier strip 2 with tape pieces 3. The slide continues from the vertical part 16 through a curved part 17 to an edge 18 terminating the slide. At the edge 18, the curved part 17 has a tangent direction which is approximately perpendicular to the adjacent first portion 11 of the peripheral wall 10. A top horizontal part 19 of the pressure base element 15 constitutes an abutment for the first adjacent wall portion 11 to limit the movement of the pressure base portion 14 in the direction toward said wall portion 11.

Along the essentially horizontal top portion 10a of the peripheral wall 10, as seen in FIG. 2, a double wall 20 extends, a canal 21 being formed between the peripheral wall 10 and the double wall 20. Through this canal 21, the carrier strip 2 may pass. At the downstream end of the double wall 20, a tear-off edge 22 for tearing off the carrier strip 2 is provided. The design of this tear-off edge according to the present invention will be described in detail below with reference to FIG. 71.

The pressure base portion 14 has at the stub shaft 9 a cam 23 extending down between two teeth 6 in the cogging of the hub 5 when the pressure base portion 14 is in its rest position. Both the teeth 6 and the cam 23 have, as seen in FIG. 2, essentially parallel sides, the cam 5 not being inclined to be pushed out of engagement if a force tries to turn the roll 1 while the cam 23 is in engagement with the teeth 6.

By pressure on the pressure base element 15 in a direction toward the first adjacent side wall 11, the entire pressure base portion 14 will rotate about the hinged portion 13 and the cam 23 will be moved toward the centre of the hub 5 and out of engagement with the teeth 6.

Rotation of the roll 1 is thus prevented when the pressure base portion 14 is in its rest position, however, feasible when a sufficiently pressure on the pressure base element 15 has turned the pressure base portion 14 such that the cam 23 is out of engagement with the teeth 6.

FIG. 6 shows the support 7 with the roll 1 embedded in a box 24 essentially encompassing the support and roll, however, corners 25 of the support 7 project from the box 24. The box 24 has in its one end a flap 26 with a loop 27 for suspension in a sales exhibition. The box 24 acts thus as a sales packaging. The box 24 has a perforation 28 by which the end with the flap 26 can be torn off, the bottom parts of the roll 1 and the pressure base element 15 being uncovered for use of the device. It is to be noted that the device when suspended in the loop 27 hap the bottom up. The remaining part of the box 24 acts thus as a protection of the device, prevents the roll from falling off the support 7, and makes it more comfortable for a user to seize the device without risking to seize the roll itself 1 and unintentionally impede its rotation. During use, a part 29 of the side wall of the box 24 is turned away from the side wall 11 of the support as shown with a broken line in FIG. 6 in order to give access to the side wall 11 as will be described below.

FIG. 7 shows the device without the roll 1 and the carrier strip 2 with a view to better showing the tear-off edge 22a, which in this embodiment forms a “V”, which is concave relative to the material of the corner 25, in which it has been formed. FIG. 7 shows the outlet of the canal 21, in which the carrier strip 2 is guided, when a roll 1 has been mounted. The edges of the V are provided with bevels 30 for establishing a comparatively sharp tear-off edge 22a. This edge is, as will be seen in FIG. 7, symmetrical relative to a vertical (as seen in the figure) centre plane of the device. The apex of the V 31 forms an angle of approximately 90°, but angles in the range of 40-140°, in particular the range of 60-120°, can be used.

The device is used in the following way.

The bottom part of the box is torn off along the perforation 28 and the part 29 of the side wall of the box is turned away from the side wall 11 or is completely torn off. Subsequently, the user seizes with one hand the support 7 with the double wall 20 facing the palm of the hand. With his index finger, the user pulls the carrier strip 2 along the wall portion 11 in the direction of the arrow 30. This entails a traction in the pressure base element 15 toward the adjacent wall portion 11 and the cam 23 is brought out of engagement with the teeth 6, the pressure base portion 14 being rotated about the hinged portion 13. A continuous traction in the carrier strip 2 along the wall portion 11 entails that the carrier strip 2 with tape pieces 3 is pulled forward from the roll 1 along the vertical part 16 and the curved part 17 of the pressure base element 15 to the edge 18. At this place, the carrier strip 2 turns sharply around the corner to continue up toward and along the wall portions 11. The tape pieces 3 have a rigidity which implies that they release their adhesive grip in the carrier strip 2 at the edge 18 and let themselves be forwarded in the tangent direction of the pressure base element 15 as seen in FIG. 2.

At this time, the advance of the carrier strip 2 is stopped and the tape piece 3 is pressed against a surface 32, on which it is to be placed, e.g. a piece of paper or cardboard, subsequently to adhere a photo on the place. When the device is then lifted, the tape piece will as it adheres to the surface 32 pull the carrier strip 2 and draw further a small length hereof off the roll 1. However, the pressure against the pressure base element 15 will thus be released and the pressure base portion 14 returns to its rest position, the cam 23 entering into locking engagement with the teeth 6 to block the roll 1. The tape pieces 3 will therefore be pulled free of the carrier strip 2, the louse 4 being torn.

The user may then by means of his index finger pull a new tape piece forward. The carrier strip 2 which is free from tape pieces will be pushed through the channel 21 and hampers thus not the handling of the device. After use, the free end of the carrier strip 2 is torn off against the tear-off edge 22 by pulling the end of the carrier strip 2 perpendicularly out from the backside of the device.

1. A device for dispensing two-sided adhesive pieces of an adhesive, comprising a support supporting a roll of a carrier strip carrying a strip or pieces of a two-sided adhesive, in which support the roll can rotate at the dispensing of carrier strip and adhesive, a free end of the carrier strip being pulled out of the support along a wall portion thereof, said wall portion being, at a downstream end relative to the movement of the carrier strip during dispensing, provided with a tear-off edge for tearing off the carrier strip, wherein the tear-off edge has a V-shape, which is concave relative to the wall portion.

2. A device according to claim 1, wherein the V-shape is symmetrical relative to the free end of the carrier strip in the support during its dispensing from the support.

3. A device according to claim 1, wherein the V has an apex angle of 40-140°, preferably 60-120°.

4. A device according to claim 1, wherein the sides of the V are substantially rectilinear.

5. A device according to claim 1, wherein the wall portion with the tearing edge is made from cardboard.

6. A device according to claim 1, wherein the wall portion with the tearing edge is made from plastics.

7. A device according to claim 1, wherein, said carrier strip is made from paper.

8. A device according to claim 1, wherein the adhesive is a two-sided adhesive film.

9. A device according to claim 1, wherein the adhesive is a tape coated with an adhesive on both sides.
